(19) United States
(12) Patent Application Publication
(10) Pub. No.: US 2025/0001870 A1
(43) Pub. Date: Jan. 2, 2025

(54) TELESCOPIC CURRENT COLLECTOR FOR ELECTRIC VEHICLE

(71) Applicant: GAD HARAN DEVELOPMENT LTD, Haifa (IL)

(72) Inventor: Gad Haran, Haifa (IL)

(73) Assignee: GAD HARAN DEVELOPMENT LTD, Haifa (IL)

(21) Appl. No.: 18/693,128

(22) PCT Filed: Sep. 28, 2022
(86) PCT No.: PCT/IL2022/051028

§ 371 Date: Mar. 18, 2024

Related U.S. Application Data
(60) Provisional application No. 63/251,729, filed on Oct. 4, 2021.

(51) Int. Cl. B60L 5/08; B60L 5/12; B60L 50/53

(52) U.S. Cl. CPC B60L 5/08; B60L 5/12; B60L 50/53

(57) ABSTRACT

Telescopic current collector for delivering power to electric vehicle from overhead transmission line. A telescopically extendable and retractable mast includes plurality of hollow mast sections with collector head coupled to top mast section. Pneumatic assembly selectively regulates air pressure in mast sections. Winch assembly includes rotatable winch drum and winch cable wound around winch drum and coupled to top mast section. In deployment configuration, mast is extended by selectively extending winch cable and selectively increasing pressure in mast sections to propel successive telescopic extension thereof, raising and engaging collector head with contact line of transmission line. In storage configuration, mast is retracted by selectively retracting winch cable and reducing pressure within mast sections, to propel successive telescopic retraction of mast sections, disengaging and pulling down collector head from contact line to enable foldable storage. Cable displacement measurement of winch cable may be used to regulate height of extended mast.

### FIELD OF THE INVENTION

The present invention generally relates to mechanisms for supplying electrical power from an overhead powerline to an electric ground vehicle.

### BACKGROUND OF THE INVENTION

Electric propulsion of vehicles by connection to overhead transmission powerlines has been implemented worldwide for over a century. Such electric 1o propulsion is commonly applied in two fields of transportation: railway vehicles, such as electric trains and tramways; and road vehicles, primarily inter-city trolleybuses (electric buses). Railway vehicles typically utilize a single overhead transmission line, while trolleybuses typically utilize two overhead transmission lines. In recent years there have been attempts to introduce overhead transmission lines above highways for electrically powering large trucks and other road freight transport vehicles. One such example is the “eHighway” system of Siemens Mobility.

A standard mechanical device used to derive electrical power from the overhead transmission line is commonly known as a “pantograph”. This name is due to its diamond-shaped structure resembling that of a pantograph drafting tool having a pair of mechanical arms connected in a parallelogram type configuration. A pantograph includes movable parallel arms that support a contact head, also referred to by alternative terms such as “collector head”, “pan-head”, and “collector shoe”, which directly engages with the overhead powerline and operates as an electric current collector. In particular, the pantograph arms push the contact head against the underside of a contact wire suspended from the overhead powerline or catenary in order to draw current for powering the vehicle. The pantograph arms can raise and lower the contact head using a set of springs and pneumatic actuators.

Another type of current collector mechanism is a trolley pole, which is found in trolleybuses. A trolley pole is composed of a long rigid pole affixed to the vehicle roof and equipped with a sliding strip at its distal end. The pole presses the sliding strip, such as via a spring mechanism, against the overhead powerline to draw current for powering the vehicle. A trolley bus generally requires two trolley poles and overhead lines (i.e., one for the positive current, another for the negative or neutral return) and therefore uses two parallel poles and lines. In comparison with a pantograph, a trolley pole cannot accommodate higher travel speeds and is more difficult to raise and lower automatically. Accordingly, trolley poles are typically limited to relatively low vehicle speeds (e.g., up to around 80 km/h), which is usually sufficient for inter-city transportation but less suitable for high-speed transportation. Consequently, a prevailing technology for highspeed electric vehicles powered by overhead transmission lines is the pantograph with its distinct structure. For example, the current-collector for the aforementioned Siemens Mobility eHighway system includes two parallel pantographs for each truck.

Modern vehicle technology is transitioning from combustion engine vehicles toward electric motors due to the prevalent demand for reduced carbon emissions. However, a reliance on batteries for electric vehicle propulsion has several drawbacks. Batteries are costly, substantially heavy, and characterized with difficulties in the recharging process and with recycling. Accordingly, enabling electric vehicle propulsion for long distance travel directly from an overhead transmission powerline, rather than by using batteries, could be economically advantageous. In this manner, electric vehicles could operate satisfactorily with smaller batteries, and the time-consuming process of stopping for battery recharging would be significantly minimized. However, solutions for implementing pantographs on small vehicles, such as minibuses, commercial vans, and private cars, are currently lacking. Existing designs of pantographs are suitable for large vehicles, such as trains, buses, trucks, and the like, but are not compact enough to be installed on smaller vehicles.

### SUMMARY OF THE INVENTION

In accordance with one aspect of the present invention, there is thus provided a telescopic current collector for delivering electrical power from an overhead transmission line to an electric vehicle on a road surface. The telescopic current collector includes a collector head, configured to draw electrical power when coupled with a contact line of the overhead transmission line. The telescopic current collector further includes a telescopically extendable and retractable mast, coupled to a roof of the electric vehicle, the mast including a plurality of mast sections in a telescopic arrangement, the collector head coupled to a top mast section of the mast. The telescopic current collector further includes a pneumatic assembly, configured to regulate air pressure within the mast sections. The telescopic current collector further includes a winch assembly, comprising a rotatable winch drum, a winch cable, wound around the drum and coupled to the top mast section, and a motor, configured to generate torque to drive a rotation of the winch drum. The telescopic current collector further includes a control unit, configured to control the winch assembly and the pneumatic assembly. The telescopic current collector is transitioned into a deployment configuration having an extended mast, by increasing pressure in the mast sections using the pneumatic assembly and extending the winch cable using the winch assembly, to propel a successive telescopic extension of the mast sections, so as to raise the collector head and engage the collector head with the contact line. The top mast section of the extended mast is selectively raised and lowered, by regulating pressure in the mast sections using the pneumatic assembly, and selectively extending and retracting the winch cable using the winch assembly, so as to maintain the collector head engaged with the contact line for powering the vehicle traveling on the road surface, and to disengage the collector head from the contact line when required. The telescopic current collector may be transitioned into a folded configuration having a retracted mast, by retracting the winch cable using the winch assembly, and reducing pressure within the mast sections using the pneumatic assembly, to propel a successive telescopic retraction of the mast sections. The pneumatic assembly may include at least one of: a pressure regulator, configured to regulate the air pressure; a pressure vessel, configured to store pressurized air; a pneumatic pipe, configured to deliver regulated air pressure through the mast sections; and a block valve, configured to selectively open and close to allow and prevent the flow of regulated air pressure through the mast sections. Increasing pressure in the mast sections using the pneumatic assembly may include admitting air at a regulated pressure to a bottom mast section of the mast, resulting in a pressure differential forcing an upward movement of the top mast section, followed by successive upward movement of lower mast sections of the mast, propelling the successive telescope extension of each of the mast sections. The top mast section may include a sealed bottom cover, configured to support a weight of the top mast section and the collector head, and support an upward contact force for engaging the collector head with the contact line, when an increased air pressure is applied by the pneumatic assembly. The winch assembly may include at least one of: gearbox, configured to increase a torque transferred from the motor; a clutch, configured to transmit an increased torque from the gearbox to the winch drum; a torsion spring, configured to provide a counter tension force to the winch drum; and an encoder, configured to detect a rotational position of the winch drum relative to an initial position corresponding to a cable displacement measurement of the winch along the winch drum. The control unit may be configured to receive the cable displacement measurement from the encoder, and to regulate a height of the extended mast in accordance with the cable displacement measurement. The mast may be mounted on a base frame coupled to the roof of the electric vehicle.

In accordance with another aspect of the present invention, there is thus provided a method for delivering electrical power from an overhead transmission line to an electric vehicle on a road surface. The method includes the step of providing a telescopic current collector comprising: a collector head, configured to draw electrical power when engaged with a contact line of said overhead transmission line; a telescopically extendable and retractable mast, coupled to a roof of the electric vehicle, the mast comprising a plurality of hollow mast sections in a telescopic arrangement, the collector head coupled to a top mast section of the mast; a pneumatic assembly, configured to regulate air pressure within the mast sections; a winch assembly, comprising a rotatable winch drum, a winch cable, wound around the winch drum, and coupled to the top mast section, and a motor, configured to generate torque to drive a rotation of the winch drum; and a control unit, configured to control the winch assembly and the pneumatic assembly. The method further includes the step of transitioning the telescopic current collector into a deployment configuration having an extended mast, by increasing pressure in the mast sections using the pneumatic assembly and extending the winch cable using the winch assembly, to propel a successive telescopic extension of the mast sections, so as to raise the collector head and engage the collector head with the contact line. The method further includes the step of selectively raising and lowering the top mast section of the extended mast, by regulating pressure in the mast sections using the pneumatic assembly, and selectively extending and retracting the winch cable using the winch assembly, so as to maintain the collector head engaged with the contact line for powering the vehicle traveling on the road surface, and to disengage the collector head from the contact line when required. The method may further include the step of transitioning the telescopic current collector into a folded configuration having a retracted mast, by retracting the winch cable using the winch assembly, and reducing pressure within the mast sections using the pneumatic assembly, to propel a successive telescopic retraction of the mast sections. The method may further include the steps of detecting a cable displacement measurement of the winch cable along the winch drum, using an encoder of the winch assembly, and regulating a height of the extended mast in accordance with the cable displacement measurement. Increasing pressure in the mast section using the pneumatic assembly may include admitting air at a regulated pressure to a bottom mast section of the mast, resulting in a pressure differential forcing an upward movement of the top mast section, followed by successive upward movement of lower mast sections of the mast, propelling the successive telescope extension of each of the mast sections.

### BRIEF DESCRIPTION OF THE DRAWINGS

The present invention will be understood and appreciated more fully from the following detailed description taken in conjunction with the drawings in which:

FIG. 1 is an illustration of a telescopic current collector for delivering electrical power from an overhead transmission line to an electric vehicle, with a contact-head support mechanism in an extended position, constructed and operative in accordance with an embodiment of the present invention;

FIG. 2 is a cross-sectional illustration of the contact-head support mechanism of a telescopic current collector for delivering electrical power from an overhead transmission line to an electric vehicle, constructed and operative in accordance with an embodiment of the present invention;

FIG. 3 is a schematic illustration of a winch assembly with an encoder for measuring winch cable displacement, constructed and operative in accordance with an embodiment of the present invention; and

FIG. 4 is an illustration of a telescopic current collector for delivering electrical power from an overhead transmission line to an electric vehicle, with the telescopic current collector in a retracted and folded configuration, constructed and operative in accordance with an embodiment of the present invention.

### DETAILED DESCRIPTION OF THE EMBODIMENTS

The present invention overcomes the disadvantages of the prior art by providing a novel configuration of a telescopic current collector to be mounted on an electric vehicle for drawing electricity from an overhead transmission line. In contrast to existing current collectors, such as standard pantograph designs composed of mechanical arms operated by springs and pneumatic actuators, the disclosed current collector is based on a telescopic mast, operated by pneumatic pressure and an electrical winch. The disclosed current collector may provide a compact configuration that enables installation on small electrical vehicles and which can be particularly beneficial for certain applications.

The telescopic current collector of the present invention for connecting an electric vehicle to an overhead transmission line is composed of two main portions: a contact head or pan-head that directly engages with the overhead transmission line (e.g., via a contact wire); and a support mechanism configured to selectively raise and lower the contact head relative to the vehicle roof using an extendable and retractable telescopic mast. The support mechanism is operative to raise the height of the contact head above the vehicle roof to press the contact head against the overhead powerline for drawing electrical power to the vehicle. The pressure enables a smooth transfer of electricity. The contact pressure should remain as constant as possible. The contact head height and upward force applied by the support mechanism may be controlled to overcome vibrations of the device, wind forces, and height variations.

As will be elaborated upon further hereinbelow, the support mechanism of the telescopic current collector includes: a base frame; a pneumatic assembly with a pressure regulator, a pressure vessel, and a block valve; a telescopic mast composed of multiple mast sections; a winch assembly that controls the mast height and facilitates its retraction; and a control unit that includes both software and hardware to regulate the operation of the support mechanism components. When the telescopic current collector is not in use, the telescopic mast may be collapsed and folded on the vehicle rooftop. When the telescopic current collector is deployed to power the vehicle, the pneumatic assembly releases regulated air pressure to the bottom section of the mast, to extend the mast upwards and convey the contact head toward the overhead powerline. The upward force pressing the contact head against the electrical line is regulated by the air pressure. In order to lower the mast height, or collapse the mast altogether, the winch assembly is actuated. The winch assembly is situated in the bottom of the mast in the base frame. A winch cable is connected within the hollow mast to an upper section of the mast. When the mast opens and extends, the winch cable is released with minimal resistance by the winch assembly. When the mast is retracted, the winch starts to draw the cable back (in the opposite direction) while overcoming the residual air pressure and friction forces so as to partially or fully retract the telescopic mast.

Non-limiting examples of embodiments of the present invention are described below with reference to the figures. Identical structures, elements or parts that appear in more than one figure are generally labelled with a same numeral in all the figures in which they appear. Dimensions of components and features shown in the figures are chosen for convenience and clarity of presentation and are not necessarily shown to scale.

The terms “contact head”, “collector head”, “pan-head”, and “collector shoe”, are used interchangeably herein to refer to a section of a current collector that directly engages with the overhead powerline and operates as an electric current collector.

The term “user” is used herein to refer to any individual person or group of persons operating a current collector or performing a method of the disclosed embodiments.

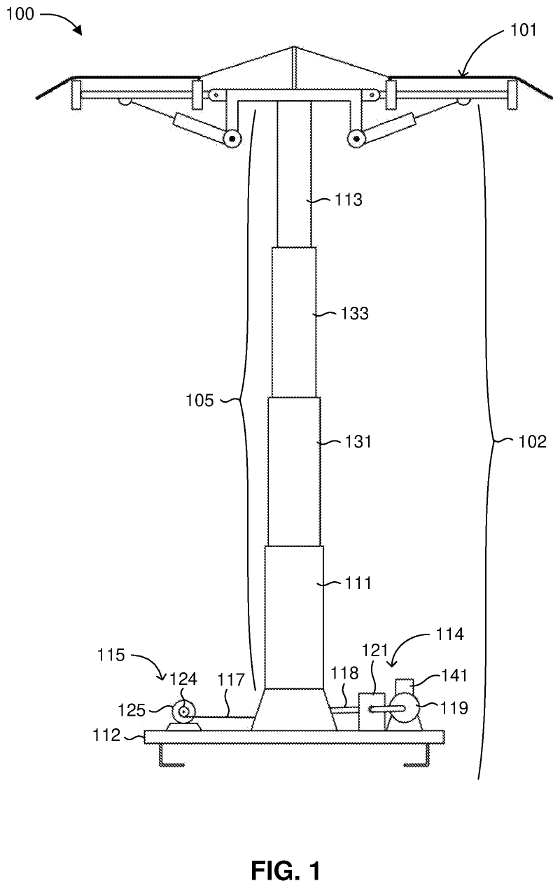

Reference is now made to FIG. 1, which is a schematic illustration of a telescopic current collector, generally referenced 100, for delivering electrical power from an overhead transmission line to an electric vehicle, with a contact-head support mechanism in an extended position, constructed and operative in accordance with an embodiment of the present invention. Telescopic current collector 100 includes a collector head 101 (also referred to herein as a contact head or a pan-head), and a collector-head support mechanism 102. Collector head 101 engages with one or more contact wires of an overhead transmission line (not shown), to draw electrical power for an electrical vehicle (i.e., a wheeled vehicle traveling on a road surface). Collector head 101 is supported by support mechanism 102 and may be a dual duty pan-head that handles two parallel contact wires simultaneously, but may alternatively be embodied by a single duty pan-head or another type of pan-head. For example, electricity may flow from collector head 101 to electrical systems of an electrical vehicle (EV) through the body of telescopic current collector 100, or when collector head 101 handles two overhead lines, electricity may flow through electric cable(s) that are attached to sliding plates of collector head 101 on one side and to the EV electrical systems on the other side. Support mechanism 102 includes a hollow telescopic mast, referenced 105, which is composed of multiple sections: a bottom mast section 111, a top mast section 113, a lower middle mast section 131 and an upper middle mast section 133. In accordance with embodiments of the present invention, a telescopic mast of the disclosed telescopic current collector may generally include any number of distinct mast sections, such as an upper section, a bottom section, and one or more middle sections, where mast 105 is depicted with four sections (and two middle sections) for exemplary purposes only. It is further appreciated that the mast sections of the disclosed telescopic current collector may be any cross-sectional shape, including but not limited to a substantially circular shape, where mast sections (111, 113, 131, 133) are described herein as being cross-sectionally circular for exemplary purposes (i.e., such that mast 105 is substantially cylindrical or pole shaped). Moreover, each of the mast sections may have a different size and/or shape. Bottom mast section 111 has a cross-sectional diameter or length larger than the other mast sections (e.g., typically 60-150 mm) and is anchored to a base frame 112. Top mast section 113 supports pan-head 101. Middle mast sections 131, 133 are positioned between bottom mast section 111 and upper mast section 113. Telescopic mast 105 is selectively extendable and retractable to enable raising or lowering the height of pan-head 101. When telescopic current collector 100 is not in use, mast sections 111, 113, 131, 133 can be retracted into one another (e.g., top section 113 within upper middle section 133 within lower middle section 131 within bottom section 111) so as to reduce the height of telescopic mast 105.

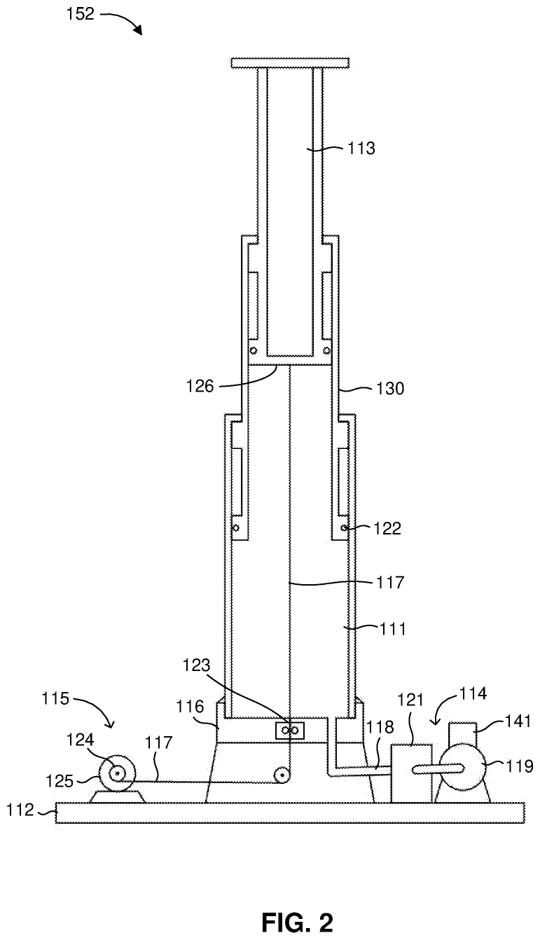

Base frame 112 includes a pneumatic assembly 114 and a winch assembly 115. A control unit (not shown) of support mechanism 102 may be situated in base frame 112 and is operative to control components of pneumatic assembly 114 and winch assembly 115, and to communicate with a vehicle computer and other electrical and control systems of the vehicle. Pneumatic assembly 114 includes an air compressor 141, a pneumatic pipe 118, a pressure vessel 119, a pressure regulator, and a block valve 121 controlled by the control unit. Winch assembly 115 may be electrically operated or a pneumatic winch, and is also controlled by the control unit of support mechanism 102. Winch assembly 115 includes a winch cable 117, which may be composed of metal or a resilient plastic material. Winch cable 117 is wound around a winch drum 124 of winch assembly 115, and the free end of winch cable is attached to top mast section 113 (as depicted in FIG. 2). Winch assembly 115 further includes a motor 125, which when activated drives the rotation of winch drum 124 to extend or retract winch cable 117.

The operation of pneumatic assembly 114 and winch assembly 115 will now be described further with reference to FIG. 2, which is a cross-sectional illustration of a contact-head support mechanism, generally referenced 152, of a telescopic current collector for delivering electrical power from an overhead 1s transmission line to an electric vehicle, constructed and operative in accordance with an embodiment of the present invention. Contact-head support mechanism 152 is generally analogous to contact-head support mechanism 102 of FIG. 1 except that the mast 105 is depicted with three mast sections (one middle section) rather than four. In particular, support mechanism 152 includes a three-section mast 105 with a bottom mast section 111, a middle mast section 130, and a top mast section 113. Bottom mast section 111 is coupled to base frame 112 and includes a closed and sealed bottom cover 116. Winch cable 117 of winch assembly 115 passes bottom cover 116 through a suitable seal 123, such as an O-ring gasket, such that the pressure within mast 105 is maintained when winch cable 117 is positioned through the seal 123, as cable 117 is generally smooth and cross-sectionally circular to facilitate sealing despite cable movement. A pneumatic pipe 118 of pneumatic assembly 114 is configured to deliver regulated air pressure and also passes through bottom cover 116 through a suitable seal. Mast 105 may include several middle mast sections 130, identical but successively smaller in length or diameter to allow each section to be inserted/retracted into the preceding section below. Each middle mast section 130 has a seal 122 between the outer surface thereof and the inner surface of the section immediately below. The bottom of middle mast sections may be open to allow winch cable 117 to pass through.

Pneumatic assembly 114 stores pressurized air, e.g., having a pressure of several bars (1 bar≡100 kPA), in a small pressure vessel 119. Air compressor 141 and pressure vessel 119 may be integrated into a single unit. Upon command from the control unit (not shown) to block valve 121 to supply air to mast 105, pressure vessel 119 releases air at a lower regulated pressure (e.g., approximately 0.3-1.0 bar) through pneumatic pipe 118 to bottom mast section 111. The resultant pressure gradually builds up within the mast sections (111, 113, 130), which forces the mast sections (111, 113, 130) upwards. In particular, the internal pressure forces the bottom of top mast section 113 upwards, which in turn compels the mast section immediately below (i.e., middle mast section 130) upwards as well, followed by the next lower section (i.e., bottom section 113), and so forth. It is noted that middle mast section 130 may be characterized with a large bottom area below seal 122 which is exposed to a small pressure above atmospheric pressure, whereas the area above seal 122 is only exposed to atmospheric pressure, resulting in a pressure differential that forces the middle mast section 130 upwards.

Each mast section 111, 113, 130 includes a mechanical stop for preventing the subsequent inner mast section from fully disengaging therefrom. In particular, the respective inner mast section is capable of telescopically extending (upwards) only up to the mechanical stop, at which a certain portion of the inner mast section protrudes above the preceding lower section while the remaining portion of the inner mast section remains embedded within the preceding lower section, to provide strength and stability to the extended mast 105.

Top mast section 113 includes a sealed bottom cover 126. The force of the air pressure applied on bottom cover 126 of top mast section 113 (when pneumatic assembly 114 is deployed) is generally sufficient to support the weight of the mast section 113 itself, in addition to the entire weight of pan-head 101 (shown in FIG. 1), as well as the upward contact force required to press against the overhead transmission line. Since the weight of top mast section 113 and pan-head 101 is known, the necessary pressure for maintaining and regulating a constant force within a desired range can be derived. The end of winch cable 117 is firmly attached to bottom cover 126 of top mast section 113.

Winch assembly 115 is operative for adjusting the height of mast 105 by selective extension and retraction. In particular, mast 105 is telescopically extended to engage contact-head 101 (FIG. 1) with a contact wire of an overhead transmission line (not shown) when deploying telescopic current collector 100 to power the vehicle (not shown), and mast 105 is retracted when telescopic current collector 100 is not use, such as to enable foldable storage of telescopic current collector 100 on the vehicle roof. Pneumatic assembly 114 is operative for controlling the contact force of collector head 101 with the overhead transmission line, by regulating the air pressure directed through mast sections 111, 113, 130.

Winch assembly 115 includes a motor 125, such as an electric motor or a pneumatic motor, configured to drive the rotation of winch drum 124 around which cable 117 is wound. One end of winch cable 117 is wound around winch drum 124, and the other end of winch cable 117 is attached to top mast section 113. As mast 105 is telescopically extended, winch cable 117 is pulled away from winch drum 124, and when necessary, winch assembly 115 will rotate winch drum 124 in the opposite direction so as to pull cable 117 and rewind it around winch drum 124. Winch assembly 115 may be further equipped with a position measurement sensor (not shown), such as an encoder, configured to measure and provide an indication of the displacement of winch cable 117 in and out of winch drum 124. The winch cable displacement may be conveyed to the control unit, which may use the information to calculate the absolute height of mast 105 1s with a high degree of precision. The mast height may then be adjusted, by controlling the free length (cable displacement) of winch cable 117 via the control unit, which restricts the ultimate height of the extended mast following the delivery of air pressure by pneumatic assembly 114, so as to ensure that pan-head 101 effectively engages with the overhead transmission line at a proper height.

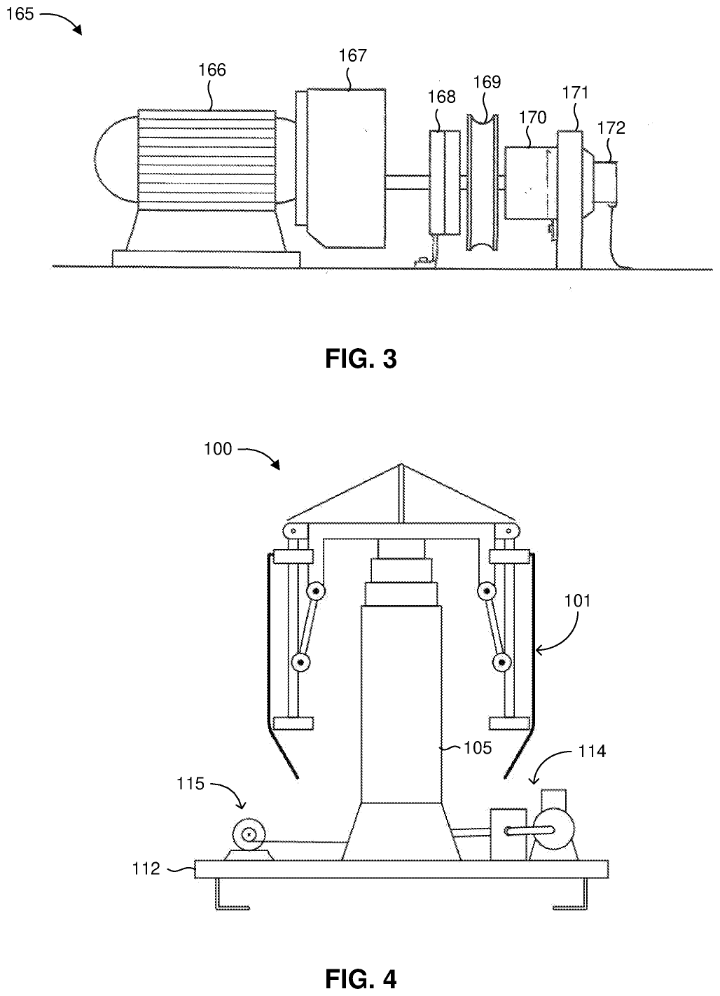

Reference is made to FIG. 3, which is a schematic illustration of a winch assembly, generally referenced 165, with an encoder for measuring winch cable displacement, constructed and operative in accordance with an embodiment of the present invention. Winch assembly 165 includes a motor 166, a gearbox 167, an electrical clutch 168, a winch drum 169, a torsion spring 170, a support bearing housing 171, and an encoder 172. At least some of the components of winch assembly 165 are coupled through a main shaft extending longitudinally through assembly 165 from motor 166 to encoder 172. Motor 166 generates rotational motion (torque) to drive the rotation of winch drum 169 through gearbox 167 and clutch 168. Specifically, motor 166 drives gearbox 167, which reduces the main shaft speed and increases the torque transferred to clutch 168. Clutch 168 is energized to transmit the increased torque from gearbox 167 to winch drum 169, propelling the rotation of winch drum 169 in a selected direction so as to selectively extend or retract winch cable 117 (FIGS. 1 and 2). Torsion spring 170 is configured to provide a counter tension force to winch drum 169. Winch assembly 165 is supported on one end by a first bearing (not shown) at gearbox 167 and at another end by a second bearing at support bearing housing 171. The extension of winch cable 117 enables the telescopic extension of mast 105, allowing collector head 101 to engage with a contact wire of an overhead transmission line to draw electrical power. Conversely, the retraction of 1s winch cable 117 enables the telescopic retraction of mast 105 and pulling down of collector head 101, allowing for the collapsing of collector head 101 into a folded configuration for storage of telescopic current collector 100. When collector head 101 is in an extended position to draw electricity from an overhead transmission line, clutch 168 is disengaged and winch drum 169 is under light tension from torsion spring 170, where the pneumatic force (applied by pneumatic assembly 114 to extend telescopic mast) is substantially greater than the tension applied by torsion spring 170. It is noted that a telescopic retraction of mast 105 by only reducing air pressure using pneumatic assembly 114 (i.e., without activating winch assembly 115) may be relatively slow, while in certain scenarios it may be beneficial to rapidly retract mast 105 in which case a further deployment of winch assembly 115 can provide quicker retraction. Encoder 172 is configured to measure the number of rotations of winch drum 169 relative to an initial position (“zero position”), corresponding to a displacement measurement of the winch cable 117. Encoder 172 may be an absolute or incremental rotary encoder that may use mechanical, optical or electromagnetic sensors to detect rotational positional changes of winch drum 169. Encoder 172 conveys the rotational positional measurement (as an electronic signal) to a control unit, which determines a height of mast 105 according to a corresponding winch cable displacement. The control unit may restrict an extension height of mast 105 if necessary, such as to provide sufficient clearance if the electrical vehicle is approaching a low bridge or other reduced height overhead structure, by limiting the extension of winch cable 117 below a maximum threshold displacement.

Thus, during operation of telescopic current collector 100, mast 105 is pressurized and extended to a height that is limited by the cable length of winch 1s cable 117, which in turn is controlled by the control unit of telescopic current collector 100. When telescopic current collector 100 is not in use and mast 105 is completely retracted, the air pressure in mast sections 111, 113, 130 is reduced at a selected rate by the control unit. Mast 105 may not be lowered solely due to its own weight because during high speed motion of the vehicle there may be side forces arising from external air flow (e.g., wind) and inertia, which may exert friction between the mast sections 111, 113, 130. The force applied by winch assembly 115 may be calculated so as to ensure the pulling of winch cable 117 is sufficient for overcoming the friction exerted by the side forces exerted during vehicle motion, so as to enable collapsing of the telescopic mast 105. Reference is made to FIG. 4, which is an illustration of a telescopic current collector for delivering electrical power from an overhead transmission line to an electric vehicle, with the telescopic current collector in a retracted and folded configuration, constructed and operative in accordance with an embodiment of the present invention. FIG. 4 shows telescopic current collector 100 with telescopic mast 105 fully retracted and collapsed and pan-head 101 folded, to facilitate storage on the vehicle roof when telescopic current collector 100 is not in use for powering the vehicle.

It is noted that a short vertical (up and down) movement of pan-head 101, such as in the range of several centimeters, due to deviations of the transmission line height above the road, will generally have a minimal effect on the pressure within mast 105, because the volume of air within mast 105 is substantially large relative to the displacement of top mast section 113. This phenomenon may have the beneficial effect of stabilizing the contact pressure between pan-head 101 and the overhead transmission line during significant fluctuations in the displacement of the transmission line in relation to the vehicle roof during vehicle motion, i.e., since the road surface levels and the height of the overhead transmission line is usually not uniform or consistent.

It will be appreciated that the disclosed telescopic current collector may be characterized by a smaller size (footprint) and reduced weight relative to existing pantograph current collectors which are typically not suitable to be installed on the roofs of small vehicles, such as standard size automobiles, minibuses, commercial vans, and the like. In addition, the disclosed telescopic current collector may be less sensitive to fluctuations in the distance between the vehicle roof top and the contact wire of the overhead transmission line, as the disclosed telescopic current collector can selectively raise or lower only an upper portion (i.e., the top mast section 113 and the pan-head 101), whereas existing pantograph current collectors need to raise and lower the entire weight of the pantograph main body.

According to an embodiment of the present invention, a method for delivering electrical power from an overhead transmission line to an electric vehicle is provided. The method includes the step of providing a telescopic current collector comprising: a collector head, configured to draw electrical power when engaged with a contact line of said overhead transmission line; a telescopically extendable and retractable mast, coupled to a roof of the electric vehicle, the mast comprising a plurality of hollow mast sections in a telescopic arrangement, the collector head coupled to a top mast section of the mast; a pneumatic assembly, configured to selectively regulate air pressure within the mast sections; and a winch assembly, comprising a rotatable winch drum, and a winch cable, wound around the winch drum, and coupled to the top mast section. The method further 1s includes the step of transitioning the telescopic current collector into a deployment configuration having an extended mast, by selectively extending the winch cable using the winch assembly, and selectively increasing pressure in the mast sections using the pneumatic assembly, to propel a successive telescopic extension of the mast sections, so as to raise the collector head and couple the collector head with the contact line. The method further includes the step of transitioning the telescopic current collector into a storage configuration having a retracted mast, by selectively retracting the winch cable using the winch assembly, and reducing pressure within the mast sections using the pneumatic assembly, to propel a successive telescopic retraction of the mast sections, so as to disengage the collector head from the contact line and pull down the collector head, allowing for foldable storage of the telescopic current collector. The method may further include the step of regulating a height of the extended mast by adjusting a cable displacement of the winch cable.

While certain embodiments of the disclosed subject matter have been described, so as to enable one of skill in the art to practice the present invention, the preceding description is intended to be exemplary only. It should not be used to limit the scope of the disclosed subject matter, which should be determined by reference to the following claims.

1. A telescopic current collector for delivering electrical power from an overhead transmission line to an electric vehicle on a road surface, the telescopic current collector comprising:
a collector head, configured to draw electrical power when coupled with a contact line of said overhead transmission line;
a telescopically extendable and retractable mast, coupled to a roof of the electric vehicle, the mast comprising a plurality of hollow mast sections in a telescopic arrangement, the collector head coupled to a top mast section of the mast;
a pneumatic assembly, configured to regulate air pressure within the mast sections;
a winch assembly, comprising: a rotatable winch drum; a winch cable, wound around the winch drum, and coupled to the top mast section; and a motor, configured to generate torque to drive a rotation of the winch drum; and
a control unit, configured to control the winch assembly and the pneumatic assembly,
wherein the telescopic current collector is transitioned into a deployment configuration having an extended mast, by increasing pressure in the mast sections using the pneumatic assembly and extending the winch cable using the winch assembly, to propel a successive telescopic extension of the mast sections, so as to raise the collector head and engage the collector head with the contact line, and
wherein the top mast section of the extended mast is selectively raised and lowered, by regulating pressure in the mast sections using the pneumatic assembly, and selectively extending and retracting the winch cable using the winch assembly, so as to maintain the collector head engaged with the contact line for powering the vehicle traveling on the road surface, and to disengage the collector head from the contact line when required.

2. The telescopic current collector of claim 1, wherein the telescopic current collector is transitioned into a folded configuration having a retracted mast, by retracting the winch cable using the winch assembly, and reducing pressure within the mast sections using the pneumatic assembly, to propel a successive telescopic retraction of the mast sections.

3. The telescopic current collector of claim 1, wherein the pneumatic assembly comprises at least one element selected from the group consisting of:
a pressure regulator, configured to regulate the air pressure;
a pressure vessel, configured to store pressurized air;
a pneumatic pipe, configured to deliver regulated air pressure through the mast sections; and
a block valve, configured to selectively open and close to allow and prevent the flow of regulated air pressure through said mast sections.

4. The telescopic current collector of claim 3, wherein increasing pressure in the mast sections using the pneumatic assembly comprises: admitting air at a regulated pressure to a bottom mast section of the mast, resulting in a pressure differential forcing an upward movement of the top mast section, followed by successive upward movement of lower mast sections of the mast, propelling the successive telescope extension of each of the mast sections.

5. The telescopic current collector of claim 4, wherein the top mast section comprises a sealed bottom cover, configured to support a weight of the top mast section and the collector head, and support an upward contact force for engaging the collector head with the contact line, when an increased air pressure is applied by the pneumatic assembly.

6. The telescopic current collector of claim 1, wherein the winch assembly further comprises at least one element selected from the group consisting of:
a gearbox, configured to increase a torque transferred from the motor;
a clutch, configured to transmit an increased torque from the gearbox to the winch drum;
a torsion spring, configured to provide a counter tension force to the winch drum; and
an encoder, configured to detect a rotational position of the winch drum relative to an initial position, corresponding to a cable displacement measurement of the winch cable along the winch drum.

7. The telescopic current collector of claim 6, wherein the control unit is configured to receive the cable displacement measurement from the encoder, and to regulate a height of the extended mast in accordance with the cable displacement measurement.

8. The telescopic current collector of claim 1, wherein the mast is mounted on a base frame coupled to the roof of the electric vehicle.

9. A method for delivering electrical power from an overhead transmission line to an electrical vehicle on a road surface, the method comprising steps of:
providing a telescopic current collector comprising:
a collector head, configured to draw electrical power when engaged with a contact line of said overhead transmission line;
a telescopically extendable and retractable mast, coupled to a roof of the electric vehicle, the mast comprising a plurality of hollow mast sections in a telescopic arrangement, the collector head coupled to a top mast section of the mast;
a pneumatic assembly, configured to regulate air pressure within the mast sections;
a winch assembly, comprising: a rotatable winch drum; a winch cable, wound around the winch drum, and coupled to the top mast section; and a motor, configured to generate torque to drive a rotation of the winch drum; and
a control unit, configured to control the winch assembly and the pneumatic assembly,
transitioning the telescopic current collector into a deployment configuration having an extended mast, by increasing pressure in the mast sections using the pneumatic assembly and extending the winch cable using the winch assembly, to propel a successive telescopic extension of the mast sections, so as to raise the collector head and engage the collector head with the contact line; and
selectively raising and lowering the top mast section of the extended mast, by regulating pressure in the mast sections using the pneumatic assembly, and selectively extending and retracting the winch cable using the winch assembly, so as to maintain the collector head engaged with the contact line for powering the vehicle traveling on the road surface, and to disengage the collector head from the contact line when required.

10. The method of claim 9, further comprising the step of transitioning the telescopic current collector into a folded configuration having a retracted mast, by retracting the winch cable using the winch assembly, and reducing pressure within the mast sections using the pneumatic assembly, to propel a successive telescopic retraction of the mast sections.

11. The method of claim 9, further comprising the steps of:
detecting a cable displacement measurement of the winch cable along the winch drum, using an encoder of the winch assembly; and
regulating a height of the extended mast in accordance with the cable displacement measurement.

12. The method of claim 9, wherein increasing pressure in the mast section using the pneumatic assembly comprises: admitting air at a regulated pressure to a bottom mast section of the mast, resulting in a pressure differential forcing an upward movement of the top mast section, followed by successive upward movement of lower mast sections of the mast, propelling the successive telescope extension of each of the mast sections.
